(19) United States
(12) Patent Application Publication
(10) Pub. No.: US 2026/0318445 A1
(43) Pub. Date: Oct. 15, 2026

(54) APPARATUSES FOR STORING A LINE ON A SUPPORT STRUCTURE

(71) Applicants: Jason Alan Sutliff, Sweet Valley, PA (US); Steven William Marsh, Hunlock Creek, PA (US)

(72) Inventors: Jason Alan Sutliff, Sweet Valley, PA (US); Steven William Marsh, Hunlock Creek, PA (US)

(21) Appl. No.: 19/642,886

(22) Filed: Apr. 9, 2026

Related U.S. Application Data
(60) Provisional application No. 63/785,855, filed on Apr. 9, 2025.
(60) Provisional application No. 63/964,196, filed on Feb. 8, 2026.

(51) Int. Cl. F16L 3/06; H02G 3/32

(52) U.S. Cl. CPC F16L 3/06; H02G 3/32

(57) ABSTRACT

An apparatus for storing an electrical line and an air line on a support structure is disclosed. The apparatus includes a bracket body directly couplable to a support structure. An air line receiver and an electrical line receiver are coupled to the bracket body. The electrical line receiver has a first end, an opposite second end, and an inner cavity extending along a receiver axis from an opening in the first end to the second end. At least a portion of the second end is located above at least a portion of the first end. A tab is coupled to the bracket body. At least a portion of the tab is located below at least a portion of the first end. The tab selectively contacts a portion of the electrical line to at least partially maintain the electrical line inserted in the inner cavity of the electrical line receiver.

### CROSS-REFERENCE TO RELATED APPLICATION

This application claims priority from U.S. Provisional Application No. 63/964,196, filed Feb. 8, 2026, for “LINE-GUARD ELECTRICAL LINE STORAGE AND PROTECTION ASSEMBLY,” and from U.S. Provisional Application No. 63/785,855, filed Apr. 9, 2025, for “ELECTRICAL AND AIR LINE STORAGE ASSEMBLY,” which are hereby incorporated by reference in their entireties including the drawings.

### TECHNICAL FIELD

The present disclosure generally relates to apparatuses and systems for holding electrical lines and air lines on support structures (e.g., tow vehicles) when not in use.

### BACKGROUND

In the transportation industry, it is common for freight of all types to be moved over the road on, or in, various types, shapes, and sizes of vehicles. The number of types of such vehicles are too numerous to exhaustively list, but many of them involve some sort of tow vehicle that can selectively couple/de-couple with some sort of towed apparatus. In many cases, the tow vehicle is generically called a tractor and the towed vehicle is generically called a trailer. Tractors are configured to be able to easily couple to and decouple from various trailers, which provides beneficial usability and efficiency, as owners of tractors can contract with various owners of trailers and be able to haul numerous types and sizes of freight as needed.

Various federal and state regulations exist that govern the design, functionality, and safety features of all components of the transportation industry, including both tractors and trailers. These regulations include, but are not limited to, regulations governing the type, style, location, safety, and quality of various features needed on tractors as well as on trailers. And, due to the enormous size and weight of not only the tractors, but also the trailers involved in transport, many regulations relate to safety issues. One such safety issue relates to the need for trailers to have adequate lighting, electrical, and braking needs when the trailer is connected to a tractor for hauling. Large trailers often include pneumatic (air) brakes that work with the braking system of the tractor towing it. In particular, air lines are available on the tractor that can be connected to air lines on the trailer such that, when the tractor and trailer are connected and the tractor brakes, air pressure in the air lines also activates the air brakes on the trailer, so as to facilitate braking of the tractor/trailer unit. When the tractor and trailer are connected, a user simply connects all the relevant lines that need to be connected between the tractor and trailer, such as, for example, electrical lines (for lighting, climate control, etc.) and air lines (for braking, as described).

When the tractor is disconnected from the trailer and driven on the road, however, something needs to be done with the air lines and electrical lines on the tractor when not in use. These lines often have considerable length, so that they can reach and be connected to the trailer when the trailer is connected to the tractor. So, when not in use, it is beneficial for these lines to be stored in some manner that is safe and handy for the drive.

Currently, brackets exist in the industry that are couplable to the tractor and configured for storing one or more air lines and one or more electrical lines on a support structure (e.g., a tractor) when the lines are not in use. FIG. 1 depicts one example of such a bracket 100 that is removably coupled to a support structure 120, which, in this illustration, is a tractor 121. The bracket 100 includes one or more air line receivers 130 (here, two air line receivers 130) having any coupling mechanism known in the art for receiving a portion of an air line 140. In the depicted embodiment, the air line receivers 130 includes gladhand receivers 133 of familiar design commonly used in the industry that receive gladhands 141 (e.g., gladhand couplings) of air lines 140 for storage. The bracket 100 also includes a socket 150 having a first socket end 151, an opposite second socket end 152, and an inner socket cavity 153 extending along a socket axis 154 from an opening 155 in the second socket end 152 to the first socket end 151. The second socket end 152 is located above the first socket end 151. Therefore, the socket 150 is designed to be top loading, where an electrical connector 161 of an electrical line 160 is inserted downwards (or at least partially downwards) along the socket axis 154 from the opening 155 in the higher second socket end 152 toward the lower first socket end 151. While the bracket 100 (and, those similar to the depicted bracket 100) does an acceptable job storing the air lines 140, having a top-loading socket 150 for the electrical connector 161 creates significant problems. For example, the downward insertion of the electrical connector 161 into the inner socket cavity 153 causes a (e.g., sharp) bend to form in the electrical cable 162 (which houses the electrical wires and/or conductors of the electrical line 160) of the stored electrical line 160. Over a relatively short amount of time, this bend can form a severe kink in the electrical line 160, which results in one or more electrical wires/conductors in the electrical cable 162 to either break or pull out of the electrical connector 161. It is common for users to have to replace electrical lines 160 and/or electrical connectors 161 of the electrical lines 160 as a direct result of using brackets with top-loading sockets.

What is needed is an apparatus for storing lines (e.g., electrical and/or air lines) on a support structure (e.g., a tractor) when those lines are not in use. The apparatus should be such that it reduces the formation of kinks in the electrical line(s). Additionally, the apparatus should provide adequate protection for the electrical connector(s) from the elements, dirt, and debris.

### SUMMARY

In some embodiments, an improved apparatus is disclosed that address the limitations of the conventional brackets for storing lines (e.g., electrical and/or air lines) when not in use. In some embodiments, the improved apparatus disclosed herein includes one or more electrical line receivers that are bottom-loading, thereby permitting one or more electrical lines to hang in a more natural condition without undue stress from sharp bends. In some embodiments, the apparatus provides protection to received electrical line(s) from the elements, dirt, debris, and damage. In some embodiments, the apparatus, in addition to including one or more electrical line receivers, also includes one or more air line receivers for storing one or more associated air lines.

In one embodiment, an apparatus for storing an electrical line and an air line on a support structure is disclosed. The apparatus includes a bracket body directly couplable to a support structure. An air line receiver is coupled to the bracket body. The air line receiver selectively receives a portion of an air line. An electrical line receiver is coupled to the bracket body. The electrical line receiver has a first end, an opposite second end, and an inner cavity extending along a receiver axis from an opening in the first end to the second end. At least a portion of the second end is located above at least a portion of the first end. The inner cavity selectively receives a portion of an electrical line. A tab is coupled to the bracket body. At least a portion of the tab is located below at least a portion of the first end. The tab selectively contacts a portion of the electrical line to at least partially maintain the electrical line inserted in the inner cavity of the electrical line receiver.

In another embodiment, an apparatus for storing an electrical line and an air line on a tow vehicle is disclosed. The apparatus includes a bracket body directly couplable to a tow vehicle. An air line receiver is coupled to the bracket body. The air line receiver selectively receives a portion of an air line. An electrical line receiver is coupled to the bracket body. The electrical line receiver has a first end, an opposite and closed second end, and an inner cavity extending along a receiver axis from an opening in the first end to the second end. At least a portion of the second end is located above at least a portion of the first end. A tab is coupled to the bracket body. At least a portion of the tab is located below at least a portion of the first end. In use, an inserted portion of an electrical line that has been inserted through the opening in the first end is at least partially prevented from egressing from the inner cavity due to contact between the tab and the electrical line.

In another embodiment, a system is disclosed. The system includes a support structure, an electrical line, an air line, and an apparatus for storing an electrical line and an air line on a support structure. The apparatus includes a bracket body directly couplable to the support structure. An air line receiver is coupled to the bracket body. The air line receiver selectively receives a portion of the air line. An electrical line receiver is coupled to the bracket body. The electrical line receiver has a first end, an opposite second end, and an inner cavity extending along a receiver axis from an opening in the first end to the second end. At least a portion of the second end is located above at least a portion of the first end. A tab is coupled to the bracket body. At least a portion of the tab is located below at least a portion of the first end. In use, an inserted portion of the electrical line that has been inserted through the opening in the first end is at least partially prevented from egressing from the inner cavity due to contact between the tab and the electrical line.

In another embodiment, a system for storing an electrical line and an air line on a support structure is disclosed. The system includes a bracket couplable to a support structure. The bracket has an air line receiver for storing an air line on the support structure and a socket configured for storing an electrical line on the support structure. The system also includes an apparatus for storing the electrical line on the support structure. The apparatus is separate from the bracket. The apparatus includes a body insertable into the socket to removably couple the apparatus to the bracket. An electrical line receiver is coupled to the body. The electrical line receiver has a first end, an opposite second end, and an inner cavity extending along a receiver axis from an opening in the first end to the second end. At least a portion of the second end is located above at least a portion of the first end. An arm is coupled to at least one of the body and the electrical line receiver. The arm extends away from the first end so as to locate at least a portion of a tab of the arm below at least a portion of the opening in the first end.

In another embodiment, an apparatus for storing a line on a support structure is disclosed. The apparatus includes a body that is couplable to a support structure. An electrical line receiver is coupled to the body. The electrical line receiver has a first end, an opposite second end, and an inner cavity extending along a receiver axis from an opening in the first end to the second end. At least a portion of the second end is located above at least a portion of the first end. A tab is positioned such that at least a portion of the tab is located below at least a portion of the first end. In use, an inserted portion of an electrical line that has been inserted through the opening in the first end is at least partially prevented from egressing from the inner cavity due to contact between the tab and the electrical line.

In yet another embodiment, an apparatus for storing an electrical line and an air line on a support structure is disclosed. The apparatus includes a bracket body that is directly couplable to a support structure. An air line receiver is coupled to the bracket body. The air line receiver is configured to receive a portion of an associated air line. An electrical line receiver is coupled to the bracket body. The electrical line receiver has a first end, an opposite second end, and an inner cavity extending along a receiver axis from an opening in the first end to the second end. At least a portion of the second end is located above at least a portion of the first end. A tab is coupled to the bracket body and located below the first end. In use, an inserted portion of an electrical line that has been inserted through the opening in the first end is at least partially prevented from egressing from the inner cavity due to contact between the tab and the electrical line.

These and other advantages and features, which characterize aspects of the invention, are described and depicted herein and in the attached figures, together forming a part hereof. For a better understanding of the aspects and improvements described herein and of the advantages and objectives attained through its use, reference should be made to the figures and to the accompanying descriptive matter, including the various appendices included and referenced herein, in which there is described example embodiments and additional information. This summary is merely provided to introduce a selection of concepts that are further described below in the detailed description, and is not intended to identify key or essential features of any claimed subject matter, nor is it intended to be used as an aid in limiting the scope of any claimed subject matter.

### BRIEF DESCRIPTION OF THE DRAWINGS

The embodiments set forth in the figures are illustrative and exemplary in nature and not intended to limit the subject matter defined by the claims. The following detailed description of the illustrative embodiments can be understood when read in conjunction with the following figures, where like structure is indicated with like reference numerals.

FIG. 1 is a perspective view of a prior art bracket in an example use environment.

FIG. 2 is a rear view of an embodiment of an apparatus for storing a line on a support structure.

FIG. 3 is a bottom view of the embodiment of FIG. 2.

FIG. 4 is a top view of the embodiment of FIG. 2.

FIG. 5 is a perspective rear view of the embodiment of FIG. 2 in an example use environment.

FIG. 6 is a perspective rear view of an alternative embodiment of an apparatus for storing a line on a support structure.

FIG. 7 is a perspective bottom view of an alternative embodiment of an apparatus for storing a line on a support structure, including a portion of the apparatus in a closed state.

FIG. 8 is a perspective side view of the embodiment of FIG. 7, including a portion of the apparatus in an opened state.

FIG. 9 is a rear view of an alternative embodiment of an apparatus for storing a line on a support structure.

FIG. 10 is a rear view of an alternative embodiment of an apparatus for storing a line on a support structure.

FIG. 11 is a side view of the embodiment of FIG. 10.

FIG. 12 is a perspective rear review of an alternative embodiment of an apparatus for storing a line on a support structure.

FIG. 13 is a cross-sectional view of an alternative embodiment of an apparatus for storing a line on a support structure.

FIG. 14 is a perspective side view of an alternative embodiment of an apparatus for storing a line on a support structure.

FIG. 15 is a perspective bottom view of the embodiment of FIG. 14.

FIG. 16 is a perspective rear view of the embodiment of FIG. 14, including the apparatus connected to a prior art bracket in an example use environment.

FIG. 17 is a side view of an alternative embodiment of an apparatus for storing a line on a support structure.

FIG. 18 is a side view of an alternative embodiment of an apparatus for storing a line on a support structure.

FIG. 19 is a schematic side view of the embodiment of FIG. 18 depicting a body of the apparatus at various angular positions.

### DETAILED DESCRIPTION

The embodiments described herein are directed an apparatus for holding or retaining one or more lines (e.g., electrical and/or air lines) on support structures (e.g., tow vehicles) when those lines are not in use. More specifically, the present disclosure relates to an improved apparatus for safely retaining one or more lines on a support structure (e.g., a tow vehicle).

For the sake of convenience, the disclosed apparatus is depicted and described for use on a tow vehicle. However, the apparatus is not limited to such construction type or location. Indeed, the apparatus is useful in the safe storage of electrical and/or air lines for any purpose, on vehicles, trailers, or otherwise. Furthermore, various embodiments of the apparatus are described in more detail herein. Whenever possible, the same reference numerals will be used throughout the Figures to refer to the same or like parts.

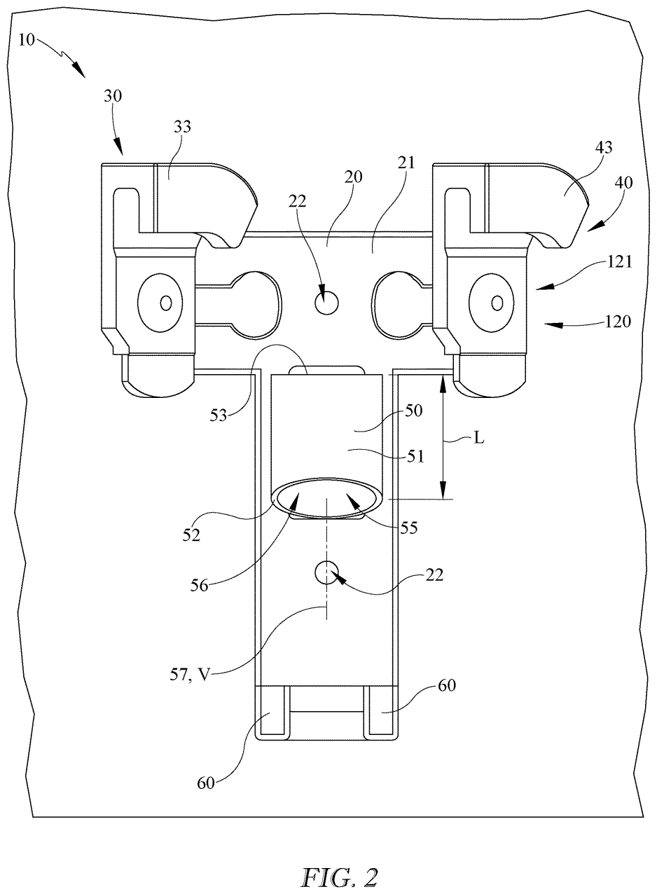

FIG. 2 is a rear view of one embodiment of an apparatus according to the teachings herein. In the embodiment shown, the apparatus 10 includes a body 20, a first air line receiver 30, a second air line receiver 40, and an electrical line receiver 50. Although the embodiment depicted includes two air line receivers, the apparatus 10 can have other numbers of air line receivers, including one or more than two. The description herein of each air line receiver 30, 40 can apply to each gladhand included in the apparatus 10 regardless of number, unless stated otherwise. Similarly, although the embodiment depicted includes one electrical line receiver 50, the apparatus 10 can include other numbers of electrical line receivers, including more than one. The description herein of the electrical line receiver 50 can apply to each electrical line receiver included in the apparatus 10 regardless of number, unless stated otherwise. Also, for the sake of simplicity in description, in the figures a reference directional system is indicated as “top”, “bottom”, etc. This is for ease of description and not meant to be limiting as to how a user might mount the apparatus 10 onto a surface. The reference directions relate only to the apparatus 10 itself.

Referring now to FIG. 2, the body 20 defines a bracket body 21 that is directly coupled to a support structure 120, which, in this example, is a tow vehicle 121, via one or more fastening mechanisms 22. In other embodiments, the support structure 120 may be an intermediate element that is coupled to a tow vehicle 121. The fastening mechanisms 22 are depicted as being apertures in the bracket body 21 that permit the passage of fasteners (e.g., screws, bolts, rivets, and so forth), which aren't shown for clarity, for the removable coupling of the bracket body 21 to the support structure 120. In other embodiments, the fastening mechanisms 22 removably coupling the bracket body 21 to the support structure 120 utilize any other fastener or fastening system (e.g., tongue/groove connections, other forms of male/female couplings, adhesives, magnets, and so forth). In yet other embodiments, the bracket body 21 may be permanently coupled to the support structure 120 via, e.g., welding or via being formed as part of the support structure 120 (such as by injection molding, forming, additive manufacturing, and the like).

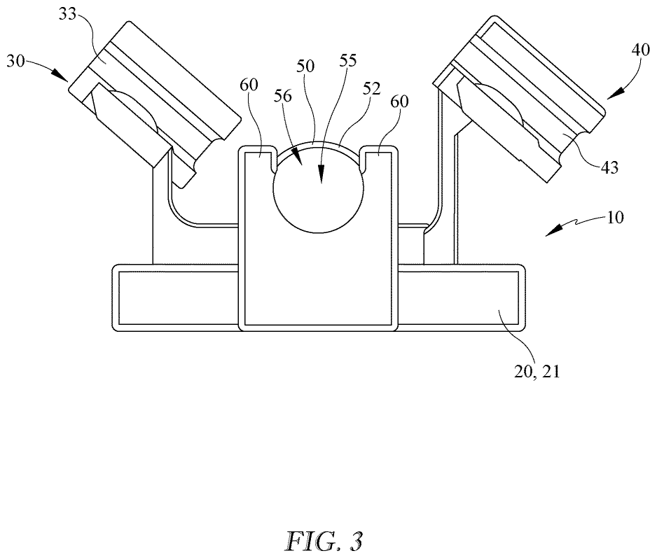

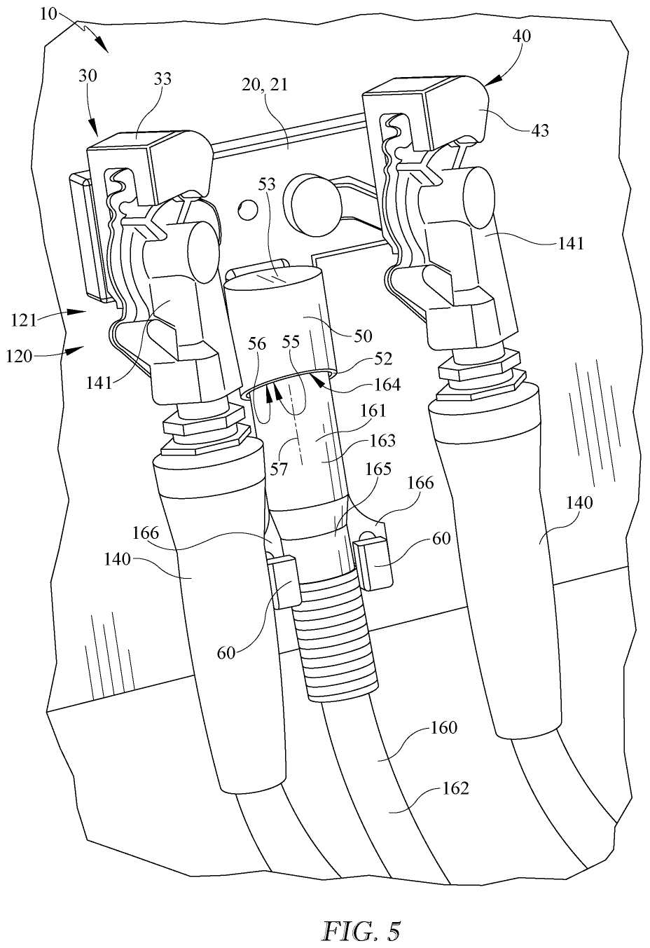

Referring now primarily to FIGS. 2 and 3, the first air line receiver 30 is coupled to the body 20. This coupling can be permanent (e.g., the first air line receiver 30 can be formed as part of the body 20, such as by injection molding, forming, additive manufacturing, and the like) or can be selectively removable (e.g., the first air line receiver 30 can be fastened to the body 20, as with fasteners or fastening systems, including, without limitation, screws, bolts, rivets, tongue/groove connections, other forms of male/female couplings, adhesives, magnets, and so forth). In the embodiment shown in FIGS. 2 and 3, the first air line receiver 30 is formed as a part of the body 20 such that the first air line receiver 30 and the body 20 are a one-piece construction. The first air line receiver 30 may include any coupling mechanism known in the art for receiving a portion of an air line. In the depicted embodiment, the first air line receiver 30 includes a first gladhand receiver 33 of familiar design commonly used in the industry for receiving gladhands (e.g., a gladhand couplings) of air lines. In particular, the first gladhand receiver 33 is configured to positively fasten a gladhand 141 of an air line 140 (see, for example, FIG. 5) upon a partial turn of the gladhand 141 within the gladhand receiver 33. The gladhand receiver 33 is disposed on the body 20 in such a manner that a gladhand 141 approaches the gladhand receiver 33 from the bottom and, when fastened, the gladhand 141 is held in the gladhand receiver 33 and the air line 140 depends downwardly from the gladhand 141.

In similar fashion, the second air line receiver 40 is coupled to the body 20. This coupling can be permanent (e.g., the second air line receiver 40 can be formed as part of the body 20, such as by injection molding, forming, additive manufacturing, and the like) or can be selectively removable (e.g., the second air line receiver 40 can be fastened to the body 20, as with fasteners or fastening systems, including, without limitation, screws, bolts, rivets, tongue/groove connections, other forms of male/female couplings, adhesives, magnets, and so forth). In the embodiment shown in FIGS. 2 and 3, the second air line receiver 40 is formed as a part of the body 20 such that the second air line receiver 40 and the body 20 are a one-piece construction. The second air line receiver 40 may include any coupling mechanism known in the art for receiving a portion of an air line. In the depicted embodiment, the second air line receiver 40 includes a second gladhand receiver 43 of familiar design commonly used in the industry for receiving gladhands (e.g., a gladhand couplings) of air lines. In particular, the second gladhand receiver 43 is configured to positively fasten a gladhand 141 of an air line 140 (see, for example, FIG. 5) upon a partial turn of the gladhand 141 within the second gladhand receiver 43. The second gladhand receiver 43 is disposed on the body 20 in such a manner that a gladhand 141 approaches the second gladhand receiver 43 from the bottom and, when fastened, the gladhand 141 is held in the second gladhand receiver 43 and the air line 140 depends downwardly from the gladhand 141.

With reference to FIGS. 2-4, an exemplary embodiment of an electrical line receiver 50 is shown. The electrical line receiver 50 is coupled to the body 20. This coupling can be permanent (e.g., the electrical line receiver 50 can be formed as part of the body 20, such as by injection molding, forming, additive manufacturing, and the like) or can be selectively removable (e.g., the electrical line receiver 50 can be fastened to the body 20, as with fasteners or fastening systems, including, without limitation, screws, bolts, rivets, tongue/groove connections, other forms of male/female couplings, adhesives, magnets, and so forth). In the embodiment shown in FIGS. 2-4, the electrical line receiver 50 is formed as a part of the body 20 such that the electrical line receiver 50 and the body 20 are a one-piece construction. The electrical line receiver 50 is sized and shaped so as to receive at least a portion of a conventional electrical connector 161 of an electrical line 160 (see, for example, FIG. 5) used in the applications involved.

The electrical line receiver 50 has a body 51 having a first end 52 and a second end 53 that is located above the first end 52. Accordingly, the first end 52 is located at a lower side of the body 51 while the second end 53 is located at an upper side of the body 51. The body 51 also has a length L that extends in a direction from the first end 52 to the second end 53. The first end 52 has an opening 56 so as to permit the passage of the electrical connector 161 therethrough.

The body 51 contains an inner cavity 55 into which at least a portion of the electrical connector 161 can be inserted for storage. The inner cavity 55 thus has dimensions adequate to receive the electrical connector 161. The inner cavity 55 extends along a receiver axis 57 that is defined by the body 51 from the opening 56 in the first end 52 to the second end 53. In the illustrated embodiment, the receiver axis 57 is aligned with and/or extends parallel to a vertical axis V and, thus, extends at a zero degree angle with respect to the vertical axis V. Accordingly, the first end 52 is directly vertically below second end 53. In other embodiments or arrangements of the apparatus 10 on the support structure 120, the receiver axis 57 may be at a non-zero degree angle relative to the vertical axis V. In such embodiments or arrangements, the angle between the receiver axis 57 and the vertical axis V may be less than 90 degrees so that the second end 53 (or at least a portion thereof) is still located above the first end 52 (or at least a portion thereof).

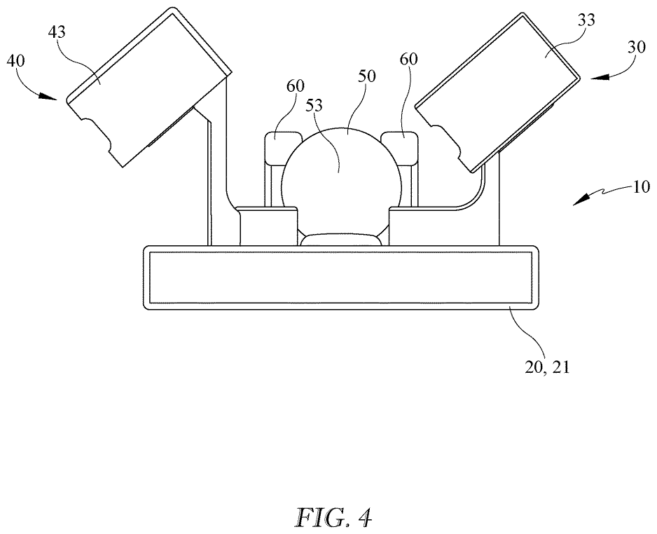

Referring now to FIG. 4, the second end 53 of the body 51 is closed. Closing the second end 53 provides protection to at least the inserted portion of the electrical connector 161 from weather, dirt, debris, and so forth. In the depicted embodiment, the closure of the second end 53 is permanent and formed via an integral portion of the body 51. In other embodiments, the second end 53 may be permanently closed via a cap. In other embodiments, the second end 53 may include an opening that can be selectively closed via a removable cap. In yet other embodiments, the second end 53 may include an opening that remains opened during use.

Referring now to FIG. 5, a typical electrical connector 161 of an electrical line 160 involved in the industry for which the apparatus 10 is suited includes a cylindrical body 163 having a first connector end 164 and a second connector end 165. The first connector end 164 contains interface structures that enable electrical connection between the electrical connector 161 and an electrical outlet into which the electrical connector 161 can be plugged. The second connector end 165 is physically connected to the electrical cable 162 that houses the electrical wires/conductors of the electrical line 160. The second connector end 165 also often contains one or more ears 166. The ears 166 can facilitate removal of the electrical connector 161 from the electrical outlet into which the electrical connector 161 can be plugged.

Referring primarily to FIGS. 2-3 and 5, the apparatus 10 can also include one or more tabs 60 (shown here as two tabs 60). The tabs 60 are positioned such that each tab 60 (or at least a portion of each tab 60) is located below the first end 52 of the electrical line receiver 50 (or below at least a portion of the first end 52 of the electrical line receiver 50). The tabs 60 are coupled to the body 20. This coupling can be permanent (e.g., the tabs 60 can be formed as part of the body 20, such as by injection molding, forming, additive manufacturing, and the like) or can be selectively removable (e.g., the tabs 60 can be fastened to the body 20, as with fasteners or fastening systems, including, without limitation, screws, bolts, rivets, tongue/groove connections, other forms of male/female couplings, adhesives, magnets, and so forth). In the embodiment shown in FIGS. 2-3 and 5, the tabs 60 are formed as a part of the body 20 such that the tabs 60 and the body 20 are a one-piece construction.

As shown in FIG. 5, the tabs 60 are configured to receive one or both ears 166 of the electrical connector 161. Accordingly, an inserted portion of the electrical connector 161 that has been inserted along or at least partially along the receiver axis 57 through the opening 56 in the first end 52 is at least partially prevented from egressing from the inner cavity 55 due to contact between the tabs 60 and the ears 166. In some embodiments, the tabs 60 can be spaced away from the electrical line receiver 50 at such a distance so as to enable a user to insert the electrical connector 161 into the inner cavity 55 of the electrical line receiver 50 with enough room to then allow the electrical connector 161 to move a small distance away from the electrical line receiver 50 such that the ears 166 rest on the tabs 60. That is, the distance from an inner surface of the closed second end 53 to an upper surface of the tabs 60 may, in some embodiments, be slightly greater than a distance between the first connector end 164 of the electrical connector 161 and a terminal (distal) end of the ears 166. As an example, for a typical electrical connector 161 that has a length of approximately 4 inches between its first connector end 164 and its ears 166, and for a electrical line receiver 50 that has a length L of approximately 2-¾ inches, the distance between the second end 53 of the electrical line receiver 50 and the tabs 60 is within a range of approximately 3 inches to approximately 7 inches.

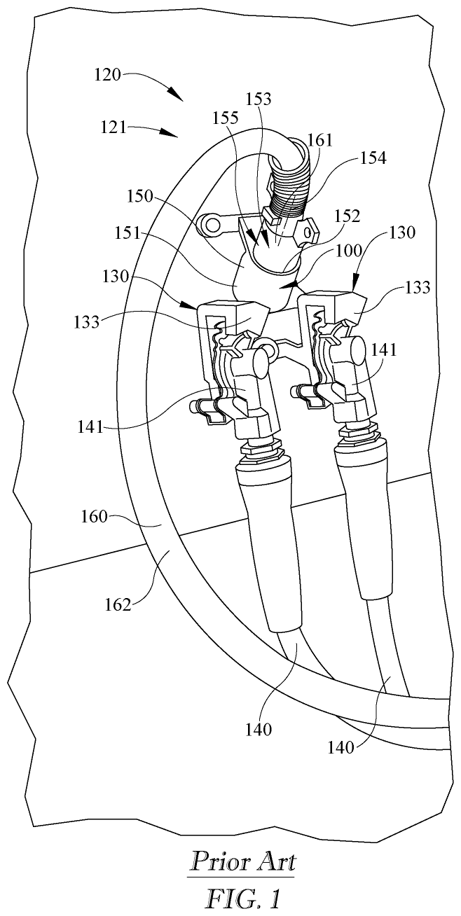

Contrary to prior art brackets, such as the one, e.g., depicted in FIG. 1, in which electrical connectors 161 enter a bracket from above, the apparatus 10 is advantageously designed such that the relatively lower end of the electrical line receiver 50 (e.g., the first end 52) has the opening 56 through which at least a portion of the electrical connector 161 is inserted. This allows the electrical connector 161 to enter the electrical line receiver 50 from below or at least partially from below, in a similar way as the air lines 140 each enter the first air line receiver 30 and second air line receiver 40, respectively from below. In other words, the electrical connector 161 is insertable along the receiver axis 57 through the opening in the first end 52 upward or at least partially upward toward the second end 53. As a result, when at least a portion of the electrical connector 161 resides within the inner cavity 55 of the electrical line receiver 50, there is no sharp bend or undue pressure applied to the electrical connector 161 or the electrical cable 162 that is stored on the apparatus 10. By alleviating the bend in the electrical line 160 required by prior art top-loading brackets, the life of the electrical line 160 and, especially, the electrical connector 161 is prolonged. For example, because the storage of the electrical line 160 imposes no sharp bend or kink in the electrical cable 162, a permanent bend or kink is not imposed on the electrical cable 162. This means that a user no longer has to try to straighten such a bend before connecting the electrical line 160 to a towed vehicle (e.g., a trailer). The repeated straightening of the electrical cable 162 because of prior art bracket designs causes additional damage to the electrical wires/conductors inside, which causes malfunction of trailer lights, which in turn is a DOT violation in itself.

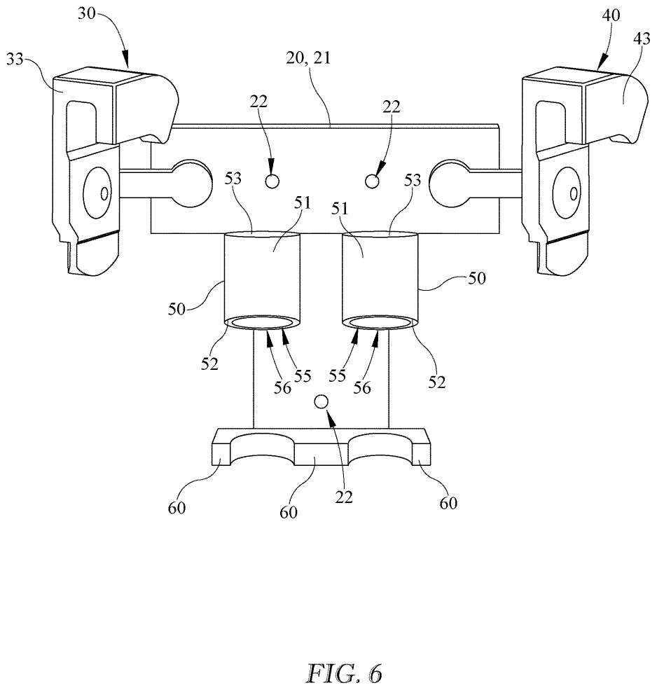

FIG. 6 is a rear view of another embodiment of an apparatus according to the teachings herein. In this embodiment, the apparatus 10 shares many structures with the embodiment shown in FIGS. 2-5, including a body 20 in the form of a bracket body 21, a first air line receiver 30, a second air line receiver 40, and fastening mechanisms 22. Additionally, the assembly includes two electrical line receivers 50. The body 20 can also include tabs 60 similar to that described above. In this embodiment, there can be two tabs 60 for each electrical line receiver 50 or, as shown in FIG. 6, the middle tabs 60 can be joined (or formed of the same piece), such that there are a total of only three tabs 60 (that is, not four as there would be if each electrical line receiver 50 still included two tabs 60). Obviously, any number of tabs 60 can be arranged on or about the body 20, so long as some structure is present against which the ears 166 of the electrical connectors 161 can rest.

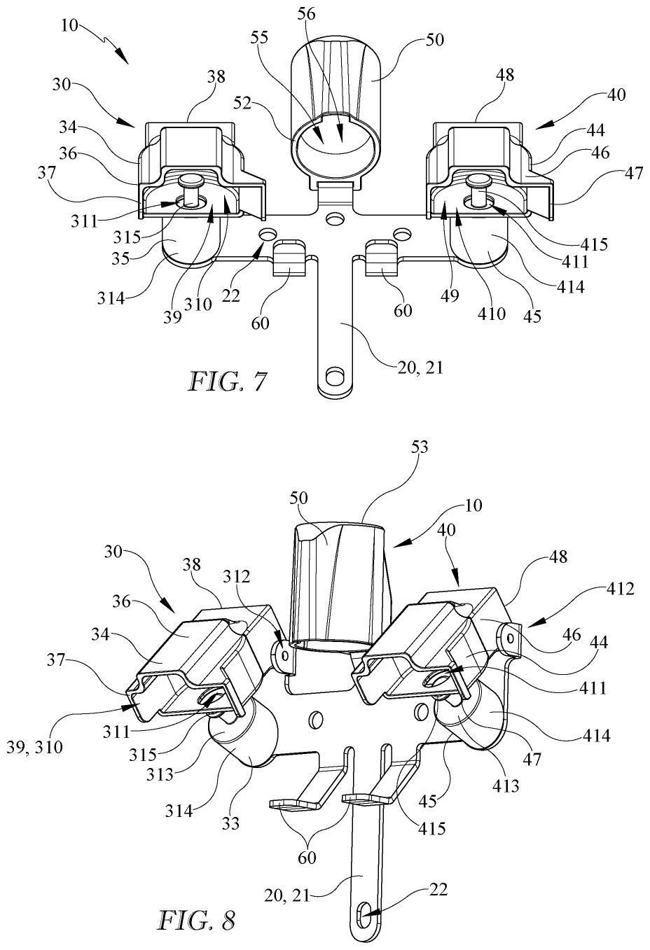

FIGS. 7-8 depict another embodiment of an apparatus according to the teachings herein. In this embodiment, the apparatus 10 shares many structures with the embodiment shown in FIGS. 2-5, including a body 20 in the form of a bracket body 21, an electrical line receiver 50, tabs 60, and fastening mechanisms 22. The apparatus 10 of FIGS. 7-8 also includes first and second air line receivers 30, 40. However, unlike the first and second air line receivers 30, 40 of the apparatus of FIGS. 2-5, the first and second air line receivers 30, 40 of the apparatus 10 of FIGS. 7-8 include first and second covers 34, 44 and first and second supports 35, 45.

The first cover 34 includes a body 36 having a first end 37 and a second end 38. The first end 37 has an opening 39 so as to permit the passage of a portion of an air line 140 (FIG. 1) into an inner cavity 310 of the body 36 for storage. In the depicted embodiment, the opening 39 and the inner cavity 310 are dimensioned to receive at least a portion of a gladhand 141 (FIG. 1) for storage, though the opening 39 and the inner cavity 310 may be dimensioned to receive other types of air line couplings in other embodiments. The inner cavity 310 extends from the opening 39 to the second end 38, which is closed. Closing the second end 38 provides protection to at least the inserted portion of the gladhand 141 from weather, dirt, debris, and so forth. Located between the first end 37 and the second end 38 is a side opening 311 in the body 36 that extends transverse (e.g., perpendicular) to the opening 39 in the first end 37.

The body 36 of the first cover 34 may be hingedly coupled to the bracket body 21 via a hinge mechanism 312. Accordingly, the first cover 34 may be pivoted between a closed state and an opened state. In the closed state (FIG. 7), a portion of the body 36 may contact (or at least be positioned adjacent to) a contact surface 313 of the first support 35. In particular, the first support 35 includes a platform 314 that extends from the bracket body 21 to the contact surface 313 of the platform 314. The platform 314 may thus be coupled to the bracket body 21. This coupling can be permanent (e.g., the platform 314 can be formed as part of the bracket body 21, such as by injection molding, forming, additive manufacturing, and the like) or can be selectively removable (e.g., the platform 314 can be fastened to the bracket body 21, as with fasteners or fastening systems, including, without limitation, screws, bolts, rivets, tongue/groove connections, other forms of male/female couplings, adhesives, magnets, and so forth). In the embodiment shown in FIGS. 7-8, the platform 314 is formed as a part of the bracket body 21 such that the platform 314 and the bracket body 21 are a one-piece construction.

The first support 35 may also include a prong 315 that extends away from the contact surface 313. In the closed state, a portion of the prong 315 extends through the side opening 311 and into the inner cavity 310. In the opened state (FIG. 8), the first cover 34 is pivoted away from the contact surface 313 such that the body 36 does not contact the contact surface 313 (and/or is spaced further from the contact surface 313 than when in the closed state) and the prong 315 is outside the side opening 311 and the inner cavity 310. In other embodiments, the platform 314 may be omitted and the prong 315 may extend from the bracket body 21.

In use, the first cover 34 may be pivoted to the opened state. Once in the opened state, a gladhand 141 of an associated air line 140 may be at least partially inserted through the opening 39 and into the inner cavity 310. The inserted gladhand 141 may be positioned such that a gladhand opening (not shown), provided for the passage of air, is aligned with the side opening 311. Once the gladhand 141 is inserted and in position, the first cover 34 may be pivoted to the closed state. At least a portion of the prong 315 projects through the side opening 311 and into the gladhand opening as the first cover 34 pivots with the inserted gladhand 141 toward the closed state. Therefore, when the air line 140 is stored via the first cover 34, the first cover 34 is in the closed state, at least a portion of the gladhand 141 is received in the inner cavity 310, and the prong 315 extends into the gladhand opening of the gladhand 141. It should be appreciated that storing the air line 140 utilizes a pivoting motion of the gladhand 141 with the first cover 34 instead of a partial turning of the gladhand 141 relative to a gladhand receiver.

The second cover 44 is structurally the same as or at least substantially similar to the first cover 44. Accordingly, like the first cover 34, the second cover includes a body 46 having a first end 47 with an opening 49, a closed second end 48, an inner cavity 410 extending from the opening 49 to the second end 48, and a side opening 411 in the body 46 that extends transverse (e.g., perpendicular) to the opening 49 in the first end 47. In the depicted embodiment, the opening 49 and the inner cavity 410 are dimensioned to receive at least a portion of a gladhand 141 (FIG. 1) for storage, though the opening 49 and the inner cavity 410 may be dimensioned to receive other types of air line couplings in other embodiments. The body 46 of the second cover 44 may be hingedly coupled to the bracket body 21 via a hinge mechanism 412. Accordingly, the second cover 44 may be pivoted between a closed state (FIG. 7) and an opened state (FIG. 8). In the closed state, a portion of the body 46 may contact (or at least be positioned adjacent to) a contact surface 413 of the second support 45. In particular, the second support 45 includes a platform 414 that extends from the bracket body 21 to the contact surface 413 of the platform 414. The platform 414 may thus be coupled to the bracket body 21. This coupling can be permanent (e.g., the platform 414 can be formed as part of the bracket body 21, such as by injection molding, forming, additive manufacturing, and the like) or can be selectively removable (e.g., the platform 414 can be fastened to the bracket body 21, as with fasteners or fastening systems, including, without limitation, screws, bolts, rivets, tongue/groove connections, other forms of male/female couplings, adhesives, magnets, and so forth). In the embodiment shown in FIGS. 7-8, the platform 414 is formed as a part of the bracket body 21 such that the platform 414 and the bracket body 21 are a one-piece construction.

The second support 45 may also include a prong 415 that extends away from the contact surface 413. In the closed state, a portion of the prong 415 extends through the side opening 411 and into the inner cavity 410. In the opened state, the second cover 44 is pivoted away from the contact surface 413 such that the body 46 does not contact the contact surface 413 (and/or is spaced further from the contact surface 413 than when in the closed state) and the prong 415 is outside the side opening 411 and the inner cavity 410. In other embodiments, the platform 414 may be omitted and the prong 415 may extend from the bracket body 21. Use of the second cover 44 of the apparatus 10 of FIGS. 7-8 for the storage of a gladhand 141 of an associated air line 140 is the same as or substantially similar to that as described above with regard to the first cover 34 of the apparatus 10 of FIGS. 7-8. Accordingly, the example operation described above for storing an air line 140 with the second cover 44 will not be repeated, for brevity.

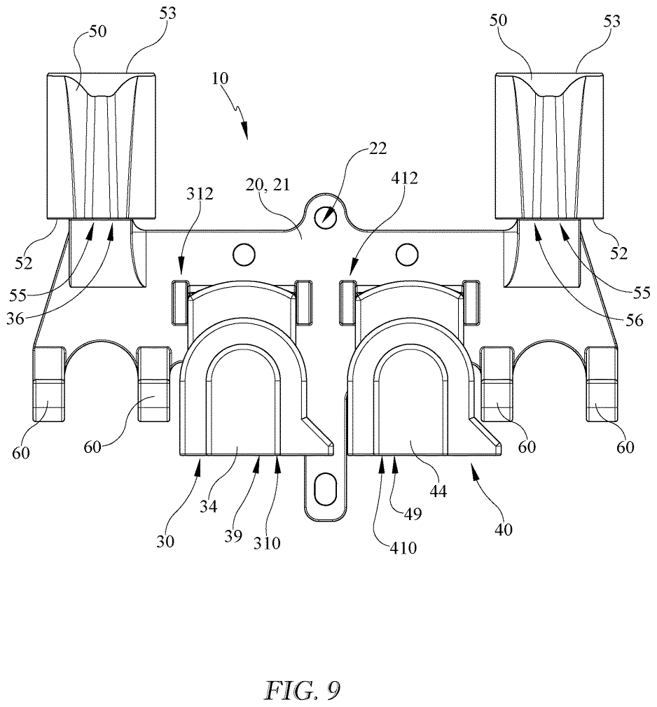

FIG. 9 depicts rear view of another embodiment of an apparatus according to the teachings herein. In this embodiment, the apparatus 10 shares many structures with the embodiment shown in FIGS. 7-8, including a body 20 in the form of a bracket body 21, a first air line receiver 30, a second air line receiver 40, and fastening mechanisms 22. Additionally, the assembly includes two electrical line receivers 50. In this embodiment, the first and second air line receivers 30, 40 are located between the two electrical line receivers 50 and there are separate tabs 60 associated with each electrical line 50 receiver. In other embodiments, the electrical line receivers 50 may be located between the first and second air line receivers 30, 40. In these other embodiments, there can be two separate tabs 60 for each electrical line receiver 50, or middle tabs 60 can be joined (or formed of the same piece), such that there are a total of only three tabs 60 (that is, not four as there would be if each electrical line receiver 50 still included two tabs 60) in a similar manner to that shown in FIG. 6. Obviously, any number of tabs 60 can be arranged on or about the body 20, so long as some structure is present against which the ears 166 of the electrical connectors 161 can rest.

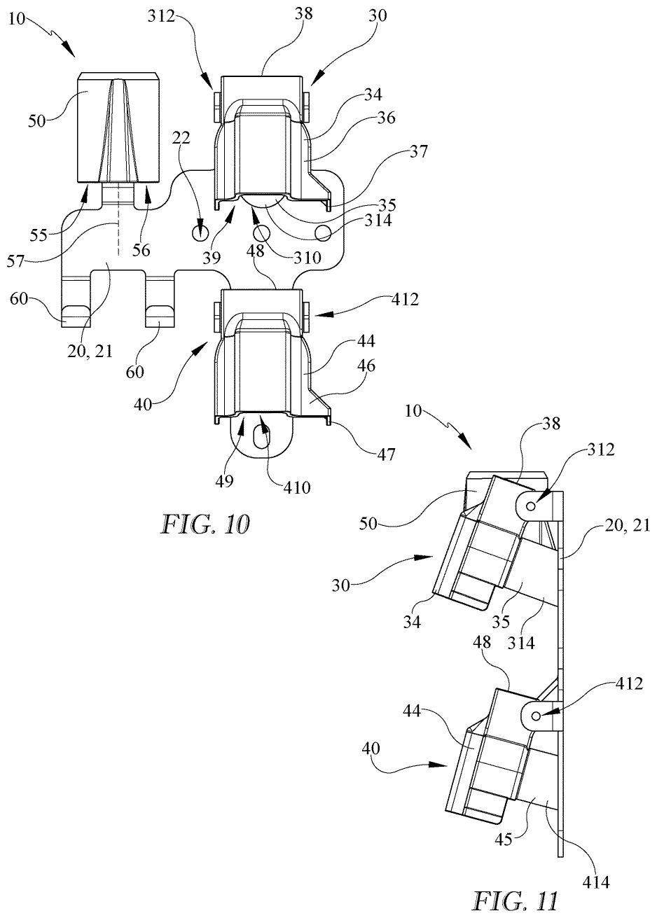

The embodiment of the apparatus 10 of FIGS. 10-11 is also structurally similar to that of the embodiment shown in FIGS. 7-8. However, while the embodiment of the apparatus 10 shown in FIGS. 7-8 depict that the first and second air line receivers 30, 40 are on opposite sides of the electrical line receiver 50, the embodiment of the apparatus 10 of FIGS. 10-11 include the first and second air line receivers 30, 40 on the same side of the electrical line receiver 50. The first and second air line receivers 30, 40 of FIGS. 10-11 are vertically stacked on the same side of the electrical receiver 50, though the first and second air line receivers 30, 40 may be offset from one another in a direction that is perpendicular, approximately perpendicular, or otherwise transverse to the receiver axis 57 in other embodiments where the first and second air line receivers 30, 40 are on the same side of the electrical receiver 50. Vertically stacking the first and second air line receivers 30, 40 on the same side of the electrical receiver 50 may be beneficial in providing a more compact apparatus 10. However, in order to accommodate such vertical stacking and the storage of associated air lines 140 in the vertically stacked first and second air line receivers 30, 40, the platform 314, 414 associated with one of the first and second air line receivers 30, 40 may extend further from the bracket body 21 than the platform 314, 414 associated with the other of the first and second air line receivers 30, 40. For example, as shown in FIG. 11, the apparatus 10 may be constructed such that the first air line receiver 30 is located above the second air line receiver 40 and the platform 314 associated with the first air line receiver 30 extends further from the bracket body 21 than the platform 414 associated with the second air line receiver 40. Further, and as depicted, at least a portion of the first cover 34 may be spaced further from the bracket body 21 than an entirety of the second cover 44.

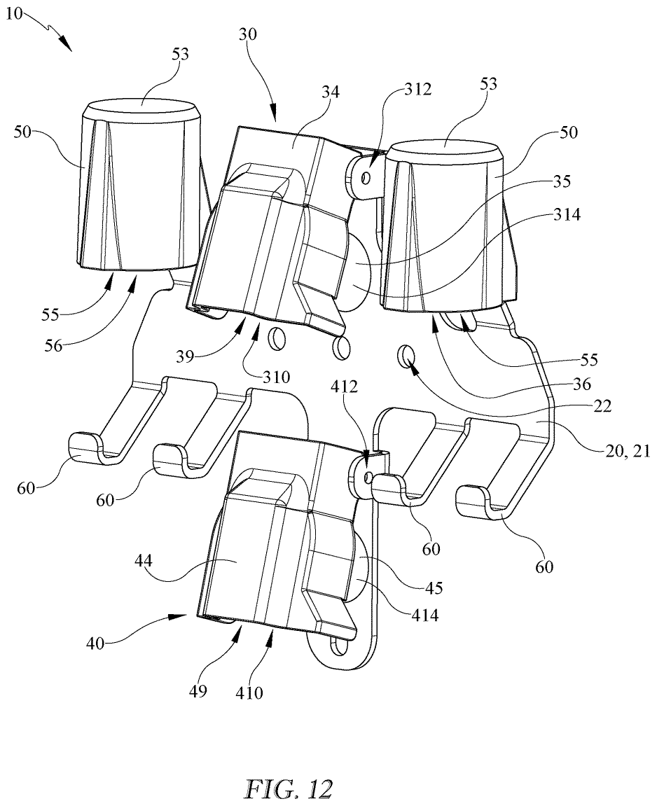

The embodiment of the apparatus 10 shown in FIG. 12 combines structures and arrangements of the embodiment of FIGS. 10-11 with those of the embodiment of FIG. 9. Accordingly, the embodiment of the apparatus 10 of FIG. 12 includes vertically stacked first and second air line receivers 30, 40 that are located between two electrical line receivers 50. In other embodiments, the electrical line receivers 50 may both be located on the same side of the stacked first and second air line receivers 30, 40. In these other embodiments, there can be two separate tabs 60 for each electrical line receiver 50, or middle tabs 60 can be joined (or formed of the same piece), such that there are a total of only three tabs 60 (that is, not four as there would be if each electrical line receiver 50 still included two tabs 60) in a similar manner to that shown in FIG. 6.

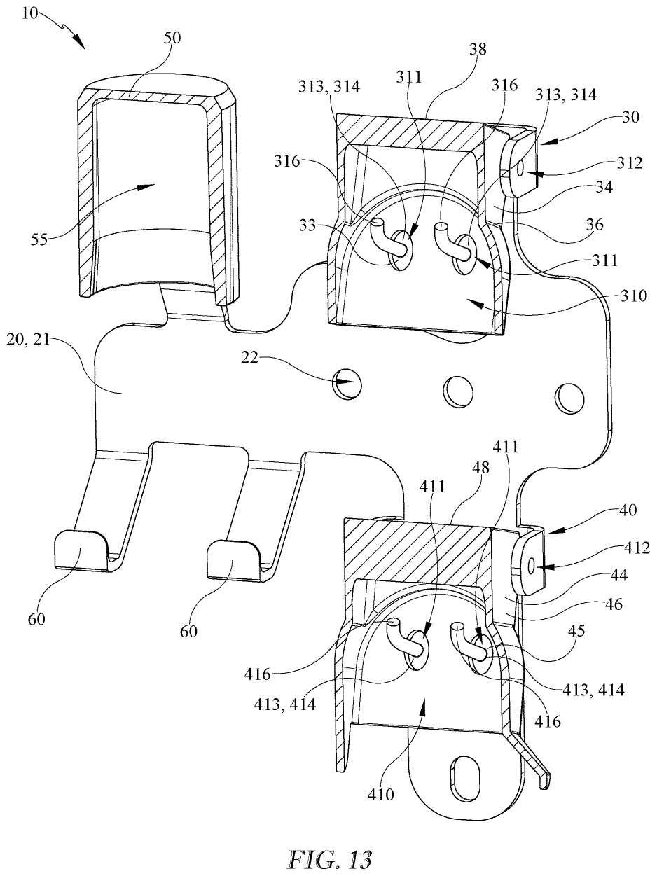

Although the embodiments of the apparatus 10 of FIGS. 7-8, 9, 10, 11, and 12 utilize prongs 315, 415 that extend through side openings 311, 411 in the first and second covers 34, 44, and into gladhand openings for storing associated air lines 140, other embodiments of the apparatus 10 may replace the prongs 315, 415 with alternative attachment mechanisms. For example, as shown in FIG. 13 instead of the prongs 315, 415, the first and second supports 35, 45 may each include one or more hanger prongs 316, 416 that extend away from the contact surfaces 313, 413. In the depicted embodiment, each of the first and second supports 35, 45 include two hanger prongs 316, 416. In the closed state of the first and second covers 34, 44 (FIG. 13), a portion of each of the hanger prongs 316, 416 extend through associated side openings 311, 411 and into an associated inner cavity 310, 410. In the opened state of the first and second covers 34, 44, the first and second covers 34, 44 are pivoted away from the contact surfaces 313, 413 and the hanger prongs 316, 416 are outside the side openings 311, 411 and the inner cavities 310, 410. In other embodiments, the platforms 314, 414 may be omitted and the hanger prongs 316, 416 may extend from the bracket body 21.

In use, the first cover 34 may be pivoted to the opened state. Once in the opened state, a gladhand 141 of an associated air line 140 may be at least partially inserted through the opening 39 and into the inner cavity 310. The inserted gladhand 141 may be positioned such that a portion of the gladhand 141 is located between the side openings 311 and the second end 38. Once the gladhand 141 is inserted and in position, the first cover 34 may be pivoted to the closed state. At least a portion of the hanger prongs 316 project through the side openings 311 as the first cover 34 pivots with the inserted gladhand 141 toward the closed state. When closed, the portion of the gladhand 141 that is located between the side openings 311 and the second end 38 contacts and rests on the hanger prongs 316 so as to selectively prevent the gladhand 141 from undesirably egressing from the inner cavity 310.

Use of the second cover 44 of the apparatus 10 of FIG. 13 for the storage of a gladhand 141 of an associated air line 140 is the same as or substantially similar to that as described above with regard to the first cover 34 of the apparatus 10 of FIG. 13. Accordingly, the example operation described above for storing an air line 140 with the second cover 44 will not be repeated, for brevity. Furthermore, it should be understood that the hanger prongs 316, 416 and associated side openings 311, 411 may be incorporated into any embodiment of the apparatus 10 that includes first and second covers 34, 44 in place of, or in addition to, the prongs 315, 416 and their associated side openings 311, 411.

While the first and second covers 34, 44 of the embodiments of the apparatus 10 shown in FIGS. 7-8, 9, 10, 11, 12, and 13 are hingedly attached to the bracket body 21 so as to be pivotable, the first and second covers 34, 44 of any of the embodiments shown in FIGS. 7-8, 9, 10, 11, 12, and 13 or any embodiment of the apparatus 10 constructed in view of the teachings provided herein may instead be fixedly connected to the bracket body 21 so that the first and second covers 34, 44 are not pivotable relative to the bracket body 21. In these fixed cover embodiments, the inner cavities 310, 411 are dimensioned so as to permit the entry of the gladhands 141 and the engagement of the gladhands 141 to the hanger prongs 316, 416. In some of these fixed cover embodiments, the hanger prongs 316, 416 still extend through the side openings 311, 411 of the first and second covers 34, 44. In others of these fixed cover embodiments, the side openings 311, 411 may be omitted and the hanger prongs 316, 416 may instead be coupled to interior surfaces of the first and second covers 34, 44.

Although the apparatuses 10 described above include a bracket body 21 that can be directly coupled to a support structure 120, other embodiments of the apparatus 10 may be constructed so as to be utilized in conjunction with conventional brackets such as, for example, the bracket 100 depicted in FIG. 1. As described above, the bracket 100 is (e.g., directly) couplable to the support structure 120 and includes at least one (here, two) air line receiver 130 for storing an air line 140 on the bracket 100 when the air line 140 is not in use. The bracket also includes at least one (here, one) socket 150 that is traditionally for receiving a portion of an electrical connector 161 therein. However, as discussed above, the socket 150 is designed to be top loading, where the electrical connector 161 of the electrical line 160 is inserted downwards (or at least partially downwards) along the socket axis 154 from the opening 155 in the higher second socket end 152 toward the lower first socket end 151, and therefore carries the issues/limitations of such brackets.

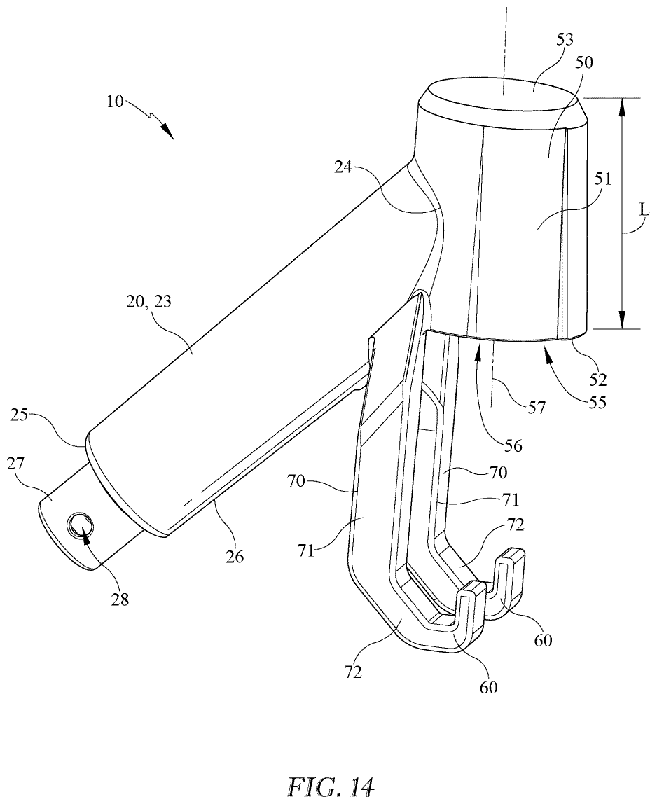

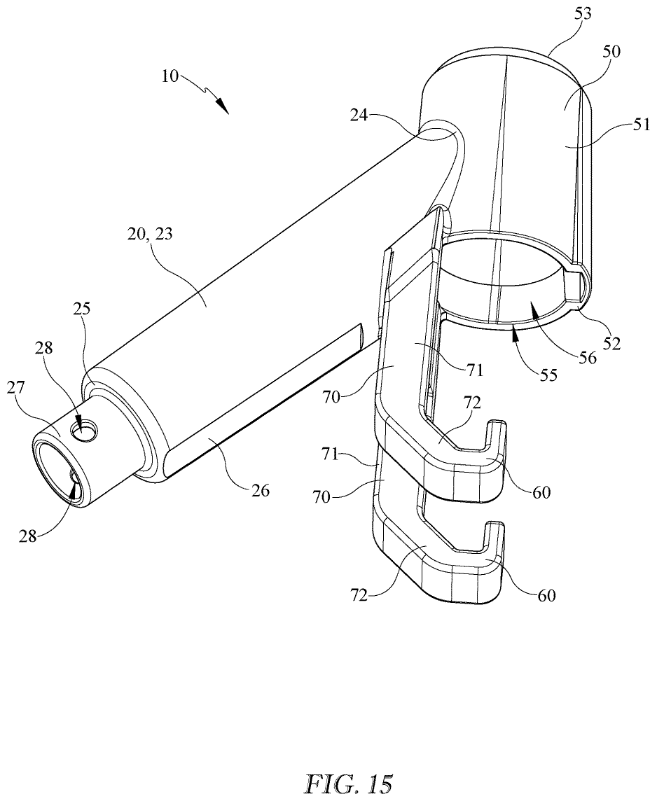

In appreciating that these brackets are commonly available and utilized in the transportation industry, the present disclosure also provides embodiments of the apparatus 10 that are useable with brackets that are designed to load associated electrical connectors 161 from above. For example, FIGS. 14-15 depicts such an embodiment of the apparatus 10. In this embodiment, the apparatus 10 shares many structures with the embodiment shown in FIGS. 2-5. For example, the apparatus 10 of FIGS. 14-15 includes an electrical line receiver 50 having a first end 52 with an opening 56, an opposite (e.g., closed) second end 53, and an inner cavity 55 that extends along a receiver axis 57 from the opening 56 in the first end 52 to the second end 53.

Similarly to the embodiment shown in FIGS. 2-5, the electrical line receiver 50 of the apparatus 10 of FIGS. 14-15 is coupled to a body 20. However, the body 20 of FIGS. 14-16 defines an insertion body 23 instead of a bracket body 21. The insertion body 23 includes a first end 24 and an opposite second end 25 that is coupled to the body 20. The insertion body 23 is substantially cylindrical and sized so as to at least partially correspond to the geometry of a commonly used electrical connector 161, though the insertion body 23 may have any other suitable shape in other embodiments. Accordingly, the insertion body 23 is sized and shaped so as to be insertable into the inner socket cavity 153. As shown in FIG. 15, the insertion body 23 may, optionally, include a flattened portion 26 for interfacing with an inner surface of the socket 150 that defines the inner socket cavity 153. For reasons that will be discussed in more detail below, the insertion body 23 may, optionally, include a projection 27 extending from the first end 24 through which one or more apertures 28 extend.

Returning back to FIGS. 14-15, the apparatus 10 of FIGS. 14-15, like that of FIGS. 2-5 has one or more tabs 60. However, unlike in the embodiment of FIGS. 2-5, the tabs 60 of the apparatus of FIGS. 14-15 are coupled to arms 70 such that they form a portion of the arms 70. It should be appreciated that the number of arms 70 in an embodiment of the apparatus 10 corresponds to the number of tabs 70. Therefore, although the embodiment depicted in FIGS. 14-15 includes two arms 70 and two tabs 60, the apparatus 10 can have other numbers of tabs 60 and arms 70, including one or more than two. When including a plurality of arms 70, the arms 70 may be spaced from one another in a direction that is perpendicular, approximately perpendicular, or otherwise transverse to the receiver axis 57.

The arms 70 are coupled to at least one of the insertion body 23 and the electrical line receiver 50. This coupling can be permanent (e.g., the arms 70 can be formed as part of the insertion body 23 and/or the electrical line receiver 50, such as by injection molding, forming, additive manufacturing, and the like) or can be selectively removable (e.g., the arms 70 can be fastened to the insertion body 23 and/or the electrical line receiver 50, as with fasteners or fastening systems, including, without limitation, screws, bolts, rivets, tongue/groove connections, other forms of male/female couplings, adhesives, magnets, and so forth). In the embodiment shown in FIGS. 14-15, the arms 70 are formed as a part of the insertion body 23 and the electrical line receiver 50 such that the insertion body 23, the electrical line receiver 50, the arms 70, and the tabs 60 are a one-piece construction. Accordingly, the embodiment of the apparatus 10 depicted in FIGS. 14-15 is a one-piece construction.

Each arm 70 may extend from its coupling point away from the first end 52 of the electrical line receiver 50 so as to locate an associated tab 60 below the opening 56 in the first end 52. In particular, each arm 70 may include a first arm potion 71 that extends parallel or substantially parallel to the receiver axis 57 away from the first end 52 of the electrical line receiver 50. For reasons that will be discussed in more detail below, a second arm portion 72 of each arm 70 may extend at an oblique angle from an associated first arm portion 71 to an associated tab 60.

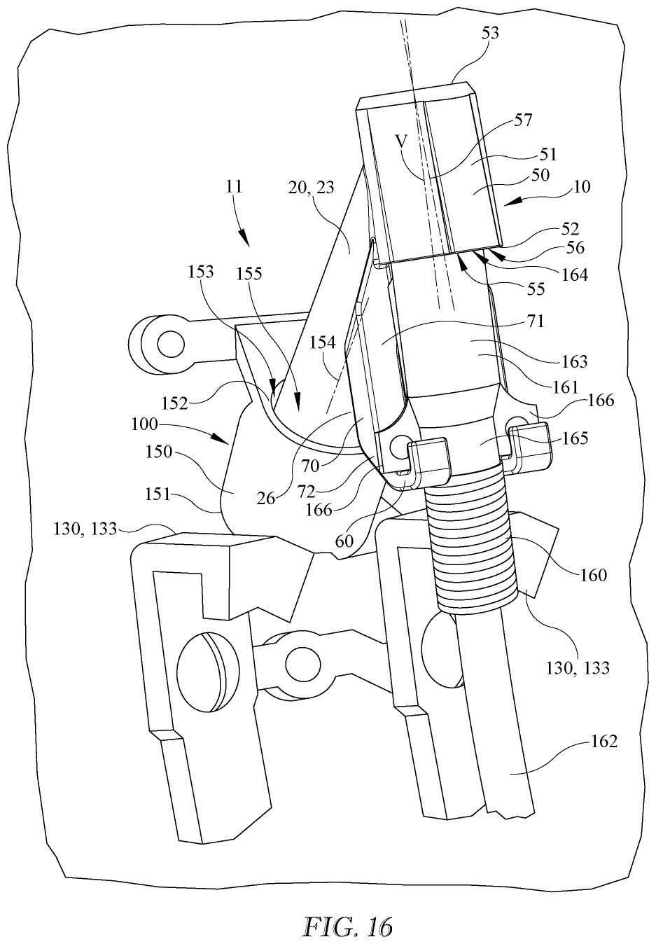

As shown in FIG. 16, the tabs 60 are configured to receive one or both ears 166 of the electrical connector 161. Accordingly, an inserted portion of the electrical connector 161 that has been inserted along or at least partially along the receiver axis 57 through the opening 56 in the first end 52 is at least partially prevented from egressing from the inner cavity 55 due to contact between the tabs 60 and the ears 166. In some embodiments, the tabs 60 can be spaced away from the electrical line receiver 50 at such a distance so as to enable a user to insert the electrical connector 161 into the inner cavity 55 of the electrical line receiver 50 with enough room to then allow the electrical connector 161 to move a small distance away from the electrical line receiver 50 such that the ears 166 rest on the tabs 60. It should be appreciated the obliquely angled second arm portions 72 help guide the ears 166 to the tabs 60 when the electrical connector 161 moves the small distance away from the electrical line receiver 50. The distance from an inner surface of the closed second end 53 to an upper surface of the tabs 60 thus may, in some embodiments, be slightly greater than a distance between the first connector end 164 of the electrical connector 161 and a terminal (distal) end of the ears 166. As an example, for a typical electrical connector 161 that has a length of approximately 4 inches between its first connector end 164 and its ears 166, and for a electrical line receiver 50 that has a length L of approximately 2-¾ inches, the distance between the second end 53 of the electrical line receiver 50 and the tabs 60 is within a range of approximately 3 inches to approximately 7 inches.

FIG. 16 also shows that the insertion body 23 has been removably inserted along the socket axis 154 downward or at least partially downward into the inner socket cavity 153 to removably couple the apparatus 10 to the bracket 100, which results in the apparatus 10 being removably coupled to the support structure 120 via the bracket 100. The inserted insertion body 23 may utilized various fastening mechanisms to selectively maintain the insertion body 23 in the inner socket cavity 153. For example, in some embodiments, an adhesive or adhesive tape may be applied to the flattened portion 26 of the insertion body 23 so as to at least temporarily secure the apparatus 10 to the bracket 100 at the location where the insertion body 23 has a stable interface with the socket 150. In some embodiments where the projection 27 is provided, a fastener (e.g., a screw, a bolt, or a rivet) may be inserted through the apertures 28 of the projection 27 after the insertion body 23 has been inserted into the inner socket cavity 153 to selectively secure the apparatus 10 to the bracket 100.

Continuing to refer to FIG. 16, it should be appreciated that the second end 53 (or at least a portion thereof) of the electrical line receiver 50 is located above the first end 52 (or at least a portion thereof) when the apparatus 10 is joined to the support structure 120 via the bracket 100 so that an electrical connector 161 enters the inner cavity 55 from below or at least partially from below when being placed in the electrical line receiver 50. This is at least due in part to the geometry of the apparatus 10 and/or the geometry of the socket 150 of the bracket 100. For example, an extension of the insertion body 23 from the electrical line receiver 50 is such that the receiver axis 57 extends parallel to or at a less than 90 degree angle relative to the vertical axis V when the apparatus 10 is joined to the bracket 100, which thereby results in the second end 53 (or at least a portion thereof) of the electrical line receiver 50 being located above the first end 52 (or at least a portion thereof). In the depicted embodiment, the insertion body 23 extends at an oblique angle from the electrical line receiver 50 so that the receiver axis 57 extends at a less than 90 degree angle relative to the vertical axis V when the insertion body 23 is removably inserted into the socket 150.

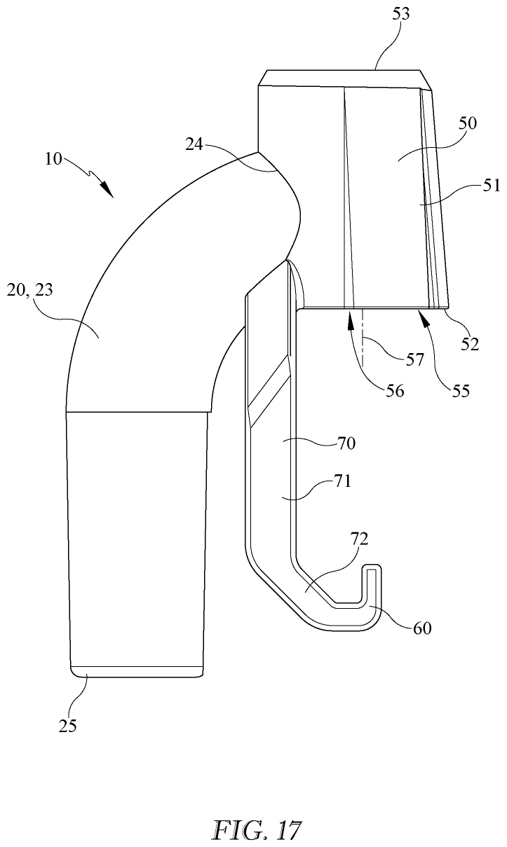

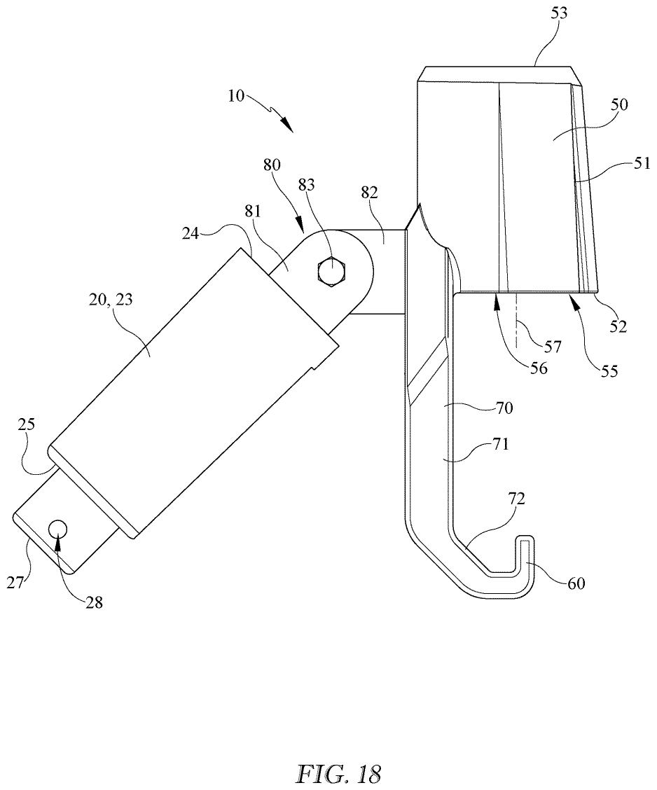

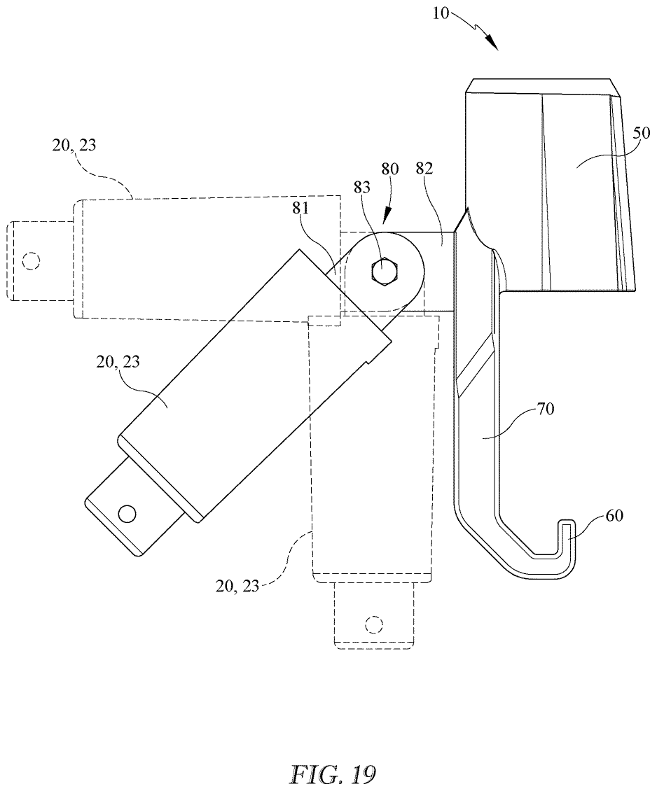

In other embodiments, the extension of the insertion body 23 may be different in order to interface with a particular bracket 100 and provide for a bottom-loading electrical line receiver 50. For example, as shown in FIG. 17, the insertion body 23 may extend from the electrical line receiver 50 in an arcuate manner so as to interface with a particular bracket and in such a manner that the second end 53 (or at least a portion thereof) of the electrical line receiver 50 is located above the first end 52 (or at least a portion thereof) when the apparatus 10 is joined to the support structure 120 via the bracket. In yet other embodiments, the angle/manner in which the insertion body 23 from the electrical line receiver 50 may be adjustable so as to account for various types of brackets and/or mounting arrangements. For example, as shown in FIG. 18, the insertion body 23 can be hingedly coupled to the electrical line receiver 50 so that the electrical line receiver 50 and the insertion body 23 are pivotable relative to one another. The embodiment of the apparatus 10 of FIG. 18 thus includes a hinge mechanism 80 having a first hinge tab 81 (permanently or removably) coupled to the first end 24 of the insertion body 23 and a second hinge tab 82 (permanently or removably) coupled to the electrical line receiver 50. A fastener 83 extends through the first and second hinge tabs 81, 82 to provide the hinged coupling. In the example embodiment shown in FIG. 18, the arms 70 are coupled to and extend from the electrical line receiver 50. As shown in FIG. 19, the insertion body 23 may be pivoted about the fastener 83 relative to the electrical line receiver 50 to various positions. Once in a position suitable for a particular bracket, the fastener 83 may be tightened to prevent the insertion body 23 (and/or the electrical line receiver 50) from pivoting from the suitable position. Loosening the fastener 83 will once again permit the insertion body 23 and the electrical line receiver 50 to pivot relative to one another. In some embodiments, the geometry of the electrical line receiver 50 and/or the insertion body 23 may permit 300 degrees of pivoting range, though the pivoting range may be different in other embodiments.

Returning to FIG. 16, it should be appreciated that a bracket 100 and an embodiment of the apparatus 10 that includes an insertion body 23 may collectively form a system 11 for storing at least one electrical line 160 and at least one an air line 140 on a support structure 120 such as, for example, a tow vehicle 121. In the depicted embodiment, the bracket 100 has air line receiver(s) 130 in the form of a gladhand receiver(s) 133 for storing an air line(s) on the support structure 120 via the bracket 100. The bracket 100 also includes the socket 150 that traditionally receives an electrical connector 161 from above. However, in this system 11, the apparatus 10, which is separate from the bracket 100, is provided for storing an electrical line 160 on the support structure 120 in a manner that corrects the limitations of the top-loading socket 150. In other words, via the coupling of the apparatus 10 to the bracket 100, the direction in which the electrical connector 161 travels so as to be stored on the support structure 120 is reversed or at least partially reversed. Instead of being loaded into the socket 150 of the bracket from above, the electrical connector 161 is inserted into the electrical line receiver 50 from or substantially from below for storage. As a result, when at least a portion of the electrical connector 161 resides within the inner cavity 55 of the electrical line receiver 50, there is no sharp bend or undue pressure applied to the electrical connector 161 or the electrical cable 162 that is stored on the apparatus 10. By alleviating the bend in the electrical line 160 traditionally required by the bracket 100, the life of the electrical line 160 and, especially, the electrical connector 161 is prolonged. It should also be appreciated that because embodiments of the apparatus 10 that have an insertion body 23 are compatible with prior art brackets, such as the bracket 100 depicted herein, and addresses their limitations, these embodiments of the apparatus 10 enable continued use of such prior art brackets without modification, removal, or replacement.

Any of the embodiments of the apparatus 10 or any of the components thereof may be formed from plastic, metal, fiberglass, carbon fiber, ceramic, rubber, or any other material.

Further aspects of the aspects described herein are provided by the subject matter of the following clauses:

An apparatus for storing an electrical line and an air line on a support structure, the apparatus comprising: a bracket body directly couplable to a support structure; an air line receiver coupled to the bracket body, the air line receiver selectively receiving a portion of an air line; an electrical line receiver coupled to the bracket body, the electrical line receiver having a first end, an opposite second end, and an inner cavity extending along a receiver axis from an opening in the first end to the second end, at least a portion of the second end being located above at least a portion of the first end, the inner cavity selectively receiving a portion of an electrical line; and a tab coupled to the bracket body, at least a portion of the tab being located below at least a portion of the first end, the tab selectively contacting a portion of the electrical line to at least partially maintain the electrical line inserted in the inner cavity of the electrical line receiver.

The apparatus of any preceding clause, wherein the second end of the electrical line receiver is closed.

The apparatus of any preceding clause, wherein an angle between the receiver axis and a vertical axis is less than 90 degrees.

The apparatus of any preceding clause, wherein the receiver axis is aligned with and extends parallel to a vertical axis.

The apparatus of any preceding clause, wherein the bracket body is directly couplable to the support structure via a fastening mechanism.

The apparatus of any preceding clause, wherein the fastening mechanism is an aperture in the bracket body.

The apparatus of any preceding clause, wherein the air line receiver includes a gladhand receiver, the gladhand receiver selectively receiving a gladhand of the air line.

The apparatus of any preceding clause, wherein the air line receiver comprises a cover hingedly coupled to the bracket body, the cover having a first cover end with a cover opening, an opposite and closed second cover end, and an inner cover cavity extending from the cover opening to the second cover end, the inner cover cavity selectively receiving a portion of the air line.

The apparatus of any preceding clause, wherein the air line receiver comprises: a platform coupled to and extending from the bracket body to a contact surface of the platform; and a hanger prong extending away from the contact surface, wherein, in a closed state of the cover, the cover is in contact with or adjacent to the contact surface and the hanger prong extends through a side cover opening in the cover into the inner cover cavity, the side cover opening extending transverse to the cover opening, and wherein, in an opened state of the cover, the cover is spaced from the contact surface and the hanger prong is outside the side cover opening and the inner cover cavity.

The apparatus of any preceding clause, wherein the air line receiver comprises a plurality of air line receivers.

The apparatus of any preceding clause, wherein the plurality of air line receivers are vertically stacked relative to one another.

The apparatus of any preceding clause, wherein the electrical line receiver comprises a plurality of electrical line receivers.

The apparatus of any preceding clause, wherein the tab comprises a plurality of tabs.

The apparatus of any preceding clause, wherein the electrical line receiver comprises a plurality of electrical line receivers, and wherein a number of tabs of the plurality of tabs is one greater than a number of electrical line receivers of the plurality of electrical line receivers.

The apparatus of any preceding clause, wherein a distance between the second end of the electrical line receiver and the tab is within a range of about 3 inches to about 7 inches.

The apparatus of any preceding clause, wherein the apparatus is a one-piece construction.

A system, comprising: a support structure; an electrical line; an air line; and an apparatus for storing an electrical line and an air line on a support structure. The apparatus comprising: a bracket body directly couplable to the support structure; an air line receiver coupled to the bracket body, the air line receiver selectively receiving a portion of the air line; an electrical line receiver coupled to the bracket body, the electrical line receiver having a first end, an opposite second end, and an inner cavity extending along a receiver axis from an opening in the first end to the second end, at least a portion of the second end being located above at least a portion of the first end; and a tab coupled to the bracket body, at least a portion of the tab being located below at least a portion of the first end, wherein, in use, an inserted portion of the electrical line that has been inserted through the opening in the first end is at least partially prevented from egressing from the inner cavity due to contact between the tab and the electrical line.

The system of any preceding clause, wherein the support structure is a tow vehicle.

An apparatus for storing a line on a support structure, the apparatus comprising: a body couplable to a support structure; an electrical line receiver coupled to the body, the electrical line receiver having a first end, an opposite second end, and an inner cavity extending along a receiver axis from an opening in the first end to the second end, at least a portion of the second end being located above at least a portion of the first end; and a tab, at least a portion of the tab being located below at least a portion of the first end, wherein, in use, an inserted portion of an electrical line that has been inserted through the opening in the first end is at least partially prevented from egressing from the inner cavity due to contact between the tab and the electrical line.

The apparatus of any preceding clause, wherein the second end is closed.

The apparatus of any preceding clause, further comprising an arm coupled to the tab and to at least one of the body and the electrical line receiver, the arm extending away from the first end so as to locate at least a portion of the tab below at least a portion of the opening in the first end.

The apparatus of any preceding clause, wherein the body defines a bracket that is directly couplable to the support structure via a fastening mechanism.

The apparatus of any preceding clause, further comprising an air line receiver coupled to the body, the air line receiver being configured to receive a portion of an air line.

An apparatus for storing an electrical line on a support structure, the apparatus comprising: a body couplable to a support structure; an electrical line receiver coupled to the body, the electrical line receiver having a first end, an opposite second end, and an inner cavity extending along a receiver axis from an opening in the first end to the second end, at least a portion of the second end being located above at least a portion of the first end; and an arm coupled to at least one of the body and the electrical line receiver, the arm extending away from the first end so as to locate at least a portion of a tab of the arm below at least a portion of the opening in the first end.

The apparatus of any preceding clause, wherein the second end of the electrical line receiver is closed.

The apparatus of any preceding clause, wherein an angle between the receiver axis and a vertical axis is less than 90 degrees.

The apparatus of any preceding clause, wherein the arm includes first and second arm portions, the first arm portion extending parallel to the receiver axis away from the first end, the second arm portion extending at an oblique angle from the first arm portion to the tab.

The apparatus of any preceding clause, wherein the arm comprises a plurality of arms each having an associated tab, the plurality of arms being spaced from one another in a direction that is approximately perpendicular to the receiver axis.

The apparatus of any preceding clause, wherein the body extends at an oblique angle from the electrical line receiver.

The apparatus of any preceding clause, wherein the body extends from the electrical line receiver in an arcuate manner.

The apparatus of any preceding clause, wherein the apparatus is a one-piece construction.

The apparatus of any preceding clause, wherein the electrical line receiver is hingedly coupled to the body so that electrical line receiver and the body are pivotable relative to one another.

An apparatus for storing an electrical line and an air line on a tow vehicle, the apparatus comprising: a bracket body directly couplable to the tow vehicle; an air line receiver coupled to the bracket body, the air line receiver selectively receiving a portion of an air line; an electrical line receiver coupled to the bracket body, the electrical line receiver having a first end, an opposite and closed second end, and an inner cavity extending along a receiver axis from an opening in the first end to the second end, at least a portion of the second end being located above at least a portion of the first end; and a tab coupled to the bracket body, at least a portion of the tab being located below at least a portion of the first end, wherein, in use, an inserted portion of an electrical line that has been inserted through the opening in the first end is at least partially prevented from egressing from the inner cavity due to contact between the tab and the electrical line.

The apparatus of any preceding clause, wherein an angle between the receiver axis and a vertical axis is less than 90 degrees.

A system for storing an electrical line and an air line on a support structure, the system comprising: a bracket couplable to a support structure, the bracket having an air line receiver for storing an air line on the support structure and a socket configured for storing an electrical line on the support structure; and an apparatus for storing the electrical line on the support structure, the apparatus being separate from the bracket, the apparatus comprising: a body insertable into the socket to removably couple the apparatus to the bracket; an electrical line receiver coupled to the body, the electrical line receiver having a first end, an opposite second end, and an inner cavity extending along a receiver axis from an opening in the first end to the second end, at least a portion of the second end being located above at least a portion of the first end; and an arm coupled to at least one of the body and the electrical line receiver, the arm extending away from the first end so as to locate at least a portion of a tab of the arm below at least a portion of the opening in the first end.

The system of any preceding clause, wherein the socket has a first socket end, an opposite second socket end, and an inner socket cavity extending along a socket axis from an opening in the second socket end to the first socket end, at least a portion of the second socket end being located above at least a portion of the first socket end, and wherein the body of the apparatus is insertable along the socket axis into the inner socket cavity to removably couple the apparatus to the bracket.

The system of any preceding clause, wherein body is substantially cylindrical and has a flattened portion for interfacing with a portion of the socket.

The system of any preceding clause, wherein the arm comprises a plurality of arms each having an associated tab, the plurality of arms being spaced from one another in a direction that is perpendicular to the receiver axis.

The system of any preceding clause, wherein the apparatus is a one-piece construction.

The system of any preceding clause, wherein the electrical line receiver is hingedly coupled to the body so that electrical line receiver and the body are pivotable relative to one another.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

What is claimed is:

1. An apparatus for storing an electrical line and an air line on a support structure, the apparatus comprising:
a bracket body directly couplable to a support structure;
an air line receiver coupled to the bracket body, the air line receiver selectively receiving a portion of an air line;
an electrical line receiver coupled to the bracket body, the electrical line receiver having a first end, an opposite second end, and an inner cavity extending along a receiver axis from an opening in the first end to the second end, at least a portion of the second end being located above at least a portion of the first end, the inner cavity selectively receiving a portion of an electrical line; and
a tab coupled to the bracket body, at least a portion of the tab being located below at least a portion of the first end, the tab selectively contacting a portion of the electrical line to at least partially maintain the electrical line inserted in the inner cavity of the electrical line receiver.

2. The apparatus of claim 1, wherein the second end of the electrical line receiver is closed.

3. The apparatus of claim 1, wherein an angle between the receiver axis and a vertical axis is less than 90 degrees.

4. The apparatus of claim 1, wherein the bracket body is directly couplable to the support structure via a fastening mechanism.

5. The apparatus of claim 4, wherein the fastening mechanism is an aperture in the bracket body.

6. The apparatus of claim 1, wherein the air line receiver includes a gladhand receiver, the gladhand receiver selectively receiving a gladhand of the air line.

7. The apparatus of claim 1, wherein the air line receiver comprises a cover hingedly coupled to the bracket body, the cover having a first cover end with a cover opening, an opposite and closed second cover end, and an inner cover cavity extending from the cover opening to the second cover end, the inner cover cavity selectively receiving a portion of the air line.

8. The apparatus of claim 7, wherein the air line receiver comprises:
a platform coupled to and extending from the bracket body to a contact surface of the platform; and
a hanger prong extending away from the contact surface,
wherein, in a closed state of the cover, the cover is in contact with or adjacent to the contact surface and the hanger prong extends through a side cover opening in the cover into the inner cover cavity, the side cover opening extending transverse to the cover opening, and
wherein, in an opened state of the cover, the cover is spaced from the contact surface and the hanger prong is outside the side cover opening and the inner cover cavity.

9. The apparatus of claim 1, wherein the air line receiver comprises a plurality of air line receivers.

10. The apparatus of claim 1, wherein the electrical line receiver comprises a plurality of electrical line receivers.

11. The apparatus of claim 1, wherein the tab comprises a plurality of tabs.

12. The apparatus of claim 11, wherein the electrical line receiver comprises a plurality of electrical line receivers, and
wherein a number of tabs of the plurality of tabs is one greater than a number of electrical line receivers of the plurality of electrical line receivers.

13. The apparatus of claim 1, wherein the apparatus is a one-piece construction.

14. An apparatus for storing an electrical line and an air line on a tow vehicle, the apparatus comprising:
a bracket body directly couplable to the tow vehicle;
an air line receiver coupled to the bracket body, the air line receiver selectively receiving a portion of an air line;
an electrical line receiver coupled to the bracket body, the electrical line receiver having a first end, an opposite and closed second end, and an inner cavity extending along a receiver axis from an opening in the first end to the second end, at least a portion of the second end being located above at least a portion of the first end; and
a tab coupled to the bracket body, at least a portion of the tab being located below at least a portion of the first end,
wherein, in use, an inserted portion of an electrical line that has been inserted through the opening in the first end is at least partially prevented from egressing from the inner cavity due to contact between the tab and the electrical line.

15. The apparatus of claim 14, wherein an angle between the receiver axis and a vertical axis is less than 90 degrees.

16. An apparatus for storing a line on a support structure, the apparatus comprising:
a body couplable to a support structure;
an electrical line receiver coupled to the body, the electrical line receiver having a first end, an opposite second end, and an inner cavity extending along a receiver axis from an opening in the first end to the second end, at least a portion of the second end being located above at least a portion of the first end; and
a tab, at least a portion of the tab being located below at least a portion of the first end,
wherein, in use, an inserted portion of an electrical line that has been inserted through the opening in the first end is at least partially prevented from egressing from the inner cavity due to contact between the tab and the electrical line.

17. The apparatus of claim 16, wherein the second end is closed.

18. The apparatus of claim 16, further comprising an arm coupled to the tab and to at least one of the body and the electrical line receiver, the arm extending away from the first end so as to locate at least a portion of the tab below at least a portion of the opening in the first end.

19. The apparatus of claim 16, wherein the body defines a bracket that is directly couplable to the support structure via a fastening mechanism.

20. The apparatus of claim 19, further comprising an air line receiver coupled to the body, the air line receiver being configured to receive a portion of an air line.
